(19) United States
(12) Patent Application Publication
(10) Pub. No.: US 2026/0221920 A1
(43) Pub. Date: Jul. 30, 2026

(54) WINDING SWITCHING SYSTEM, VEHICLE MOTOR DRIVE SYSTEM, CONTROL DEVICE, WINDING SWITCHING METHOD, AND COMPUTER PROGRAM

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Hiroki SASAKURA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/148,658

(22) PCT Filed: Dec. 8, 2023
(86) PCT No.: PCT/JP2023/044074

§ 371 Date: Jul. 16, 2025

(30) Foreign Application Priority Data
Jan. 17, 2023 (JP) 2023-005033

(51) Int. Cl. H02P 25/18; H02P 25/22; H02P 27/06

(52) U.S. Cl. CPC H02P 25/18; H02P 25/22; H02P 27/06

(57) ABSTRACT

A winding switching system for, switching a connection state of the plurality of windings, includes: a first relay set to ON when the connection state of the plurality of windings is a first connection state; a second relay set to OFF when the connection state of the plurality of windings is the first connection state; a first opening unit configured to set the first relay to OFF when the connection state is switched from the first connection state to a second connection state; a first determination unit configured to determine whether or not a contact of the first relay that has been set to OFF by the first opening unit is in an open state; and a first connection unit configured to set the second relay to ON when the first determination unit determines that the contact of the first relay is in an open state.

### CROSS-REFERENCE TO RELATED APPLICATIONS

This application is the U.S. national stage of PCT/JP2023/044074 filed on Dec. 8, 2023, which claims priority of Japanese Patent Application No. JP 2023-005033 filed on Jan. 17, 2023, the contents of which are incorporated herein.

### TECHNICAL FIELD

The present disclosure relates to a winding switching system, a vehicle motor drive system, a control device, a winding switching method, and a computer program.

### BACKGROUND

JP 2020-188597A discloses a variable-characteristic vehicle motor system in which a plurality of windings are switched by a plurality of relays to change a characteristic. In such a vehicle motor system, a plurality of windings of the motor are switched between series connection and parallel connection by a plurality of relays.

When a plurality of windings are switched between series connection and parallel connection, a plurality of relays used in the vehicle motor system disclosed in JP 2020-188597A are switched at the same time. However, even if the plurality of relays are switched at the same timing, the time until when the contact of a relay is actually in a contact state and the time until when the contact of a relay is actually in an open state may differ for each relay. For this reason, it is conceivable that the plurality of relays enter the ON state at the same time. In this case, the windings will short-circuit, causing a large induced current in a rotating rotor, which may cause the contacts to stick.

### SUMMARY

A winding switching system according to an aspect of the present disclosure is a winding switching system for, in a motor in which stators for respective phases each include a plurality of windings, switching a connection state of the plurality of windings, including: a first relay that is set to ON when the connection state of the plurality of windings is a first connection state; a second relay that is set to OFF when the connection state of the plurality of windings is the first connection state; a first opening unit configured to set the first relay to OFF when the connection state is switched from the first connection state to a second connection state; a first determination unit configured to determine whether or not a contact of the first relay that has been set to OFF by the first opening unit is in an open state; and a first connection unit configured to set the second relay to ON when the first determination unit determines that the contact of the first relay is in an open state.

The present disclosure can be realized not only as a winding switching system having the above described characteristic configuration, but also as a control device included in a winding switching system, or as a control method for a vehicle motor in which characteristic processing in a control device is used as steps. The present disclosure can be realized as a computer program that causes a computer to function as a control device, or a portion or all of the control device can be realized as a semiconductor integrated circuit.

### Advantageous Effects

According to the present disclosure, even if the connection state of the plurality of windings is switched by a plurality of relays, it is possible to prevent the relays from entering the ON state at the same time.

### BRIEF DESCRIPTION OF DRAWINGS

FIG. 1 is a diagram showing an example of a configuration of a winding switching system according to a first embodiment.

FIG. 2 is a block diagram illustrating an example of a hardware configuration of a control device.

FIG. 3 is a circuit diagram showing an example of the configuration of the winding switching device according to the first embodiment.

FIG. 4 is a circuit diagram showing an example of a configuration of a current sensor and windings according to the first embodiment.

FIG. 5 is a flowchart showing an example of winding switching processing performed by the control device according to the first embodiment.

FIG. 6 is a timing chart showing an example of winding switching processing performed by the control device according to the first embodiment.

FIG. 7 is a circuit diagram showing an example of a configuration of a winding switching device and a measurement unit according to a second embodiment.

FIG. 8 is a circuit diagram showing an example of a configuration of a modified example of a winding switching device.

### DETAILED DESCRIPTION OF PREFERRED EMBODIMENTS

Hereinafter, an overview of the embodiments of the present disclosure will be listed and described.

In a first aspect, a winding switching system according to the present embodiment is a winding switching system for, in a motor in which stators for respective phases each include a plurality of windings, switching a connection state of the plurality of windings, including: a first relay that is set to ON when the connection state of the plurality of windings is a first connection state; a second relay that is set to OFF when the connection state of the plurality of windings is the first connection state; a first opening unit configured to set the first relay to OFF when the connection state is switched from the first connection state to a second connection state; a first determination unit configured to determine whether or not a contact of the first relay that has been set to OFF by the first opening unit is in an open state; and a first connection unit configured to set the second relay to ON when the first determination unit determines that the contact of the first relay is in an open state. This makes it possible to prevent the relays from entering the ON state at the same time even when the connection state of the plurality of windings is switched from the first connection state to the second connection state by the plurality of relays.

In a second aspect according to the first aspect, the winding switching system may further include: a second opening unit configured to set the second relay to OFF when the connection state is switched from the second connection state to the first connection state; a second determination unit configured to determine whether or not a contact of the second relay that has been set to OFF by the second opening unit is in an open state; and a second connection unit configured to set the first relay to ON when the second determination unit determines that the contact of the second relay is in an open state. This makes it possible to prevent the relays from entering the ON state at the same time even when the connection state of the plurality of windings is switched from the second connection state to the first connection state by the plurality of relays.

In a third aspect according to the first or the second aspect, the first determination unit may determine that the contact of the first relay is in an open state when a current measured by a current sensor configured to measure a current flowing through a switch including the contact of the first relay is less than or equal to a threshold value. This allows the current sensor to determine whether or not the relays are in an open state.

In a fourth aspect according to the third aspect, the current sensor may be provided on a power line connecting the first relay and any one of the windings of the motor. As a result, it is sufficient that the current sensor is provided on the power line connecting the first relay and the motor, and the current sensor can be provided at various locations.

In a fifth aspect according to the third aspect, the current sensor may be provided on a power line connecting the motor and a power supply circuit configured to supply power for driving the motor. As a result, it is sufficient that the current sensor is provided on the power line connecting the power supply circuit and the motor, and for example, a current sensor provided within the power supply circuit can be used.

In a sixth aspect according to the first aspect, the first determination unit may determine whether or not the contact of the first relay is in an open state based on a voltage measured by a voltage sensor configured to measure a voltage across a switch including the contact of the first relay. This allows a voltage sensor for measuring the voltage across the switch of the relay to determine whether or not the relay is in an open state.

In a seventh aspect according to any one of the first to the sixth aspects, in the winding switching system, the plurality of windings may include a first winding and a second winding, a first terminal of the first relay may be connected to a second terminal of the first winding, a second terminal of the first relay may be connected to a first terminal of the second winding, a first terminal of the second relay may be connected to the first terminal of the second winding, and a second terminal of the second relay may be connected to a first terminal of the first winding. This makes it possible to prevent the relays from entering the ON state at the same time even when the connection state of the windings is switched between a first connection state in which two windings are connected in series and a second connection state in which one winding is connected.

In an eighth aspect according to the seventh aspect, the winding switching system may further include a third relay that is set to OFF when the connection state of the plurality of windings is the first connection state, a first terminal of the third relay may be connected to the second terminal of the first winding, a second terminal of the third relay may be connected to a second terminal of the second winding, and the first connection unit may set the third relay to ON when switching the connection state from the first connection state to the second connection state. This makes it possible to prevent the relays from entering the ON state at the same time even when the connection state of the windings is switched between a first connection state in which two windings are connected in series and a second connection state in which two windings are connected in parallel.

In a ninth aspect according to any one of the first to the eighth aspects, the first opening unit may perform notification of an instruction to suppress power for driving the motor to a power supply circuit configured to supply the power, and sets the first relay to OFF. This allows the relays to be set to OFF while the current flowing through the windings is suppressed, thereby suppressing the risk of fusion of the relay contacts and extending the life of the relays.

In a tenth aspect according to the ninth aspect, the first connection unit may set the second relay to ON, and performs notification of an instruction to restore the suppressed power to a state before suppression to the power supply circuit that supplies the power for driving the motor. This allows the power for driving the motor to be quickly returned to its original state after the winding switching system switches the connection state of the windings.

In an eleventh aspect according to any one of the first to the eighth aspects, when switching the connection state from the first connection state to the second connection state, the first opening unit may set the first relay to OFF when a notification indicating that the power for driving the motor has been suppressed is received. This allows the relays to be set to OFF while the current flowing through the windings is suppressed, thereby suppressing the risk of fusion of the relay contacts and extending the life of the relays.

In an twelfth aspect, a vehicle motor drive system according to the present embodiment includes an AC motor in which stators for respective phases each. include a plurality of windings, the AC motor being configured to drive a wheel of a vehicle; a power converter configured to convert DC power into three phase AC power for driving the AC motor; and the winding switching system according to any one of (1) to (11), configured to switch the connection state of the plurality of windings. This makes it possible to prevent the plurality of relays from entering the ON state at the same time, even in a vehicle equipped with a winding switching device that switches the connection state of the windings of the AC motor that drives the wheel of the vehicle.

In a thirteenth aspect, a control device according to the present embodiment is a control device for controlling a winding switching device for, in a motor in which stators for respective phases each include a plurality of windings, switching a connection state of the plurality of windings, the control device including: an opening unit configured to set a first relay that is set to ON when the connection state of the plurality of windings is a first connection state, to OFF when switching from the first connection state to a second connection state; a determination unit configured to determine whether or not a contact of the first relay that has been set to OFF by the first opening unit is in an open state; and a connection unit configured to set a second relay that is set to OFF when the connection state of the plurality of windings is the first connection state, to ON when the determination unit determines that the contact of the first relay is in an open state. This makes it possible to prevent the relays from entering the ON state at the same time even when the connection state of the plurality of windings is switched by the plurality of relays.

In a fourteenth aspect, a winding switching method according to the present embodiment is a winding switching method for, in a motor in which stators for respective phases each include a plurality of windings, switching a connection state of the plurality of windings, the winding switching method including: a step of setting a first relay that is set to ON when a connection state of the plurality of windings is a first connection state, to OFF when switching from the first connection state to a second connection state: a step of determining whether or not a contact of the first relay that has been set to OFF by the first opening unit is in an open state; and a step of setting a second relay that is set to OFF when the connection state of the plurality of windings is the first connection state, to ON when it is determined, in the step of determining, that the contact of the first relay is in an open state. This makes it possible to prevent the plurality of relays from entering the ON state at the same time even when the connection state of the plurality of windings is switched by the plurality of relays.

In a fifteenth aspect, a computer program according to the present embodiment is a computer program to be used by a winding switching device for, in a motor in which stators for respective phases each include a plurality of windings, switching a connection state of the plurality of windings, the computer program being configured to cause a computer to execute: a step of setting a first relay that is set to ON when a connection state of the plurality of windings is a first connection state, to OFF when switching from the first connection state to a second connection state; a step of determining whether or not a contact of the first relay that has been set to OFF by the first opening unit is in an open state; and a step of setting a second relay that is set to OFF when the connection state of the plurality of windings is the first connection state, to ON when it is determined, in the step of determining, that the contact of the first relay is in an open state. This makes it possible to prevent the plurality of relays from entering the ON state at the same time even when the connection state of the plurality of windings is switched by the plurality of relays.

Hereinafter, details of embodiments of the present disclosure will be described with reference to the drawings. Note that at least some of the embodiments described below may be combined in any manner.

### First Embodiment

### Winding Switching System

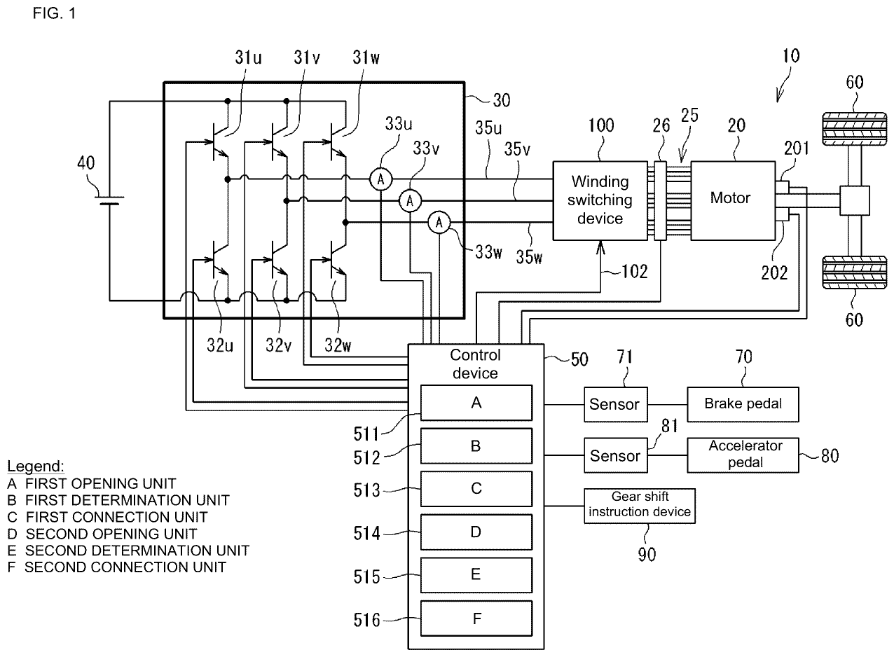

FIG. 1 is a diagram showing an example of a configuration of a winding switching system according to a first embodiment. The winding switching system 10 is mounted on a vehicle propelled by a motor, such as an electric vehicle or a plug-in hybrid vehicle (hereinafter, referred to as an “electric vehicle”). The winding switching system 10 includes a motor 20, a power converter 30, a battery 40, a control device 50, and a winding switching device 100.

The motor 20 is a travel motor that generates propulsive force for the electric vehicle. That is, the motor 20 is a drive motor that is connected to wheels 60 and drives the wheels 60. The motor 20 is driven by three phase AC power. For example, the motor 20 is a non-commutator type AC motor that does not have a commutator, but drives a stator with three phase AC power to generate a rotating magnetic field, and the rotating magnetic field rotates a rotor. Non-commutator-type AC motors include, for example, synchronous motors, reluctance motors, and induction motors.

The battery 40 is a battery for supplying power to drive the motor 20. The battery 40 is a secondary battery, and for example, a lithium ion battery.

The power converter 30 is an inverter that converts DC power supplied from the battery 40 into three phase AC power. The power converter 30 may have a function of converting three-phase AC power output when the motor 20 functions as a generator into DC power and charging the battery 40.

The power converter 30 includes a leg for each of a U-phase, a V-phase, and a W-phase. The U-phase leg includes switches 81u and 32u, the V-phase leg includes switches 31v and 32v, and the W-phase leg includes switches 31w and 32w. The switches 31u, 32u, 31v, 32v, 31w, and 32w perform switching, thereby converting the DC power into three phase AC power. The switches 31u, 32u, 31v, 32v, 31w, and 32w are, for example, insulated gate bipolar transistors (IGBTs) or metal oxide semiconductor field-effect transistors (MOSFETs).

A power line 35u corresponding to the U-phase extends from the U-phase leg, a power line 35v corresponding to the V-phase extends from the V-phase leg, and a power line 35w corresponding to the W-phase extends from the W-phase leg. In the power converter 30, a current sensor 33u is provided on the power line 35u, a current sensor 33v is provided on the power line 35v, and a current sensor 33w is provided on the power line 35w. The current sensor 33u measures the current value of a U-phase current Iu. The current sensor 33v measures the current value of a V-phase current Iv. The current sensor 33w measures the current value of a W-phase current Iw. The current sensors 33u, 33v, and 33w can measure the current values of the currents Iu, Iv, and Iw, including the DC and AC components, flowing through the power lines 35u, 35v, and 35w. The current sensors 33u, 33v, and 33w are, for example, DC current sensors (direct current sensors) using Hall sensors or shunt resistors.

The winding switching device 100 is disposed between the motor 20 and the power converter 30. The power converter 30 and the winding switching device 100 are connected by the power lines 35u, 35v, and 35w, and the winding switching device 100 and the motor 20 are connected by a plurality of power lines 25. The winding switching device 100 switches the connection state of a plurality of windings of the motor 20. The configuration of the winding switching device 100 will be described later. The three-phase AC currents Iu, Iv, and Iw output from the power converter 30 are supplied to the motor 20 via the winding switching device 100.

A measurement unit 26 measures a physical amount related to the rotation of the motor 20. An example of a physical amount related to the rotation of the motor is the current flowing through each winding of the motor 20, but there is no limitation to the current. The measurement unit 26 is provided at a location corresponding to the measurement target. When measuring the current in the power lines connecting the winding switching device 100 and the motor 20, the measurement unit 26 is provided on the power lines 212u, 221u, 212v, 221v, 212w, and 221w between the measurement unit 26 and the motor 20. The current is measured by, for example, a DC current sensor using a Hall sensor.

The control device 50 controls the motor 20. Specifically, the control device 50 controls the motor 20 by controlling the power converter 30 and the winding switching device 100. Signal lines extend from the control device 50 to the respective switches 31u, 32u, 31v, 32v, 31w, and 32w, and the control device 50 controls the switching ON and OFF of the switches 31u, 32u, 31v, 32v, 31w, and 32w. A signal line extends from the control device 50 to the winding switching device 100, and the control device 50 outputs a switching command signal for commanding the switching of the connection state of the windings to the winding switching device 100.

The control device 50 is connected to a sensor 71 that detects a depression amount of a brake pedal 70, and receives a detection signal output from the sensor 71. The control device 50 is connected to a sensor 81 that detects a depression amount of an accelerator pedal 80, and receives a detection signal output from the sensor 81.

A rotation sensor 201 for detecting the rotation speed of the motor 20 and a torque sensor 202 for detecting the output torque of the motor 20 are attached to the output shaft of the motor 20. The rotation sensor 201 and the torque sensor 202 are connected to the control device 50. The control device 50 receives a detection signal output from the rotation sensor 201 and a detection signal output from the torque sensor 202.

The control device 50 is connected to a gear shift instruction device 90. The gear shift instruction device 90 is an input device that allows the driver to input a gear shift instruction. The gear shift instruction device 90 is, for example, a shift lever. In another example, the gear shift instruction device 90 is a switch for the driver to instruct an upshift or a downshift. The gear shift instruction device 90 outputs a gear shift instruction signal in response to an operation by the driver. The control device 50 receives a gear shift instruction signal output from the gear shift instruction device 90.

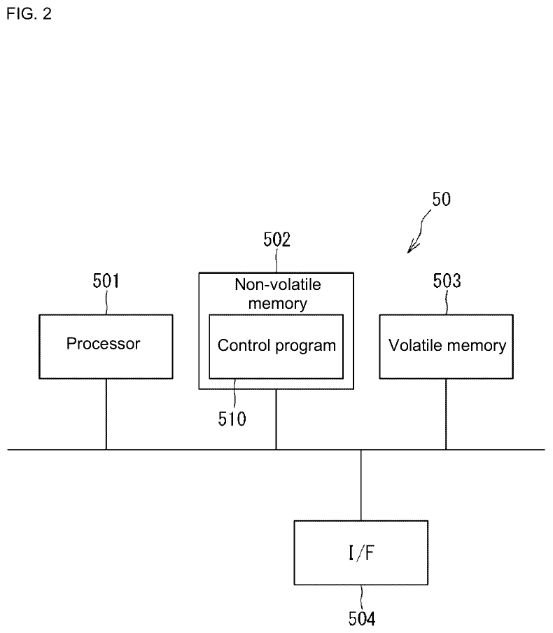

FIG. 2 is a block diagram illustrating an example of a hardware configuration of the control device. The control device 50 includes a processor 501, a non-volatile memory 502, a volatile memory 503, and an interface (I/F) 504.

The volatile memory 503 is a semiconductor memory such as a static random access memory (SRAM) or a dynamic random access memory (DRAM). The non volatile memory 502 is, for example, a flash memory, a hard disk, or a Read Only Memory (ROM). The non-volatile memory 502 stores a control program 510, which is a computer program, and data used for executing the control program 510. Each function of the control device 50 is realized by the processor 501 executing the control program 510. The control program 510 can be stored in a recording medium such as a flash memory, a ROM, or a CD-ROM. The processor 501 controls the power converter 30 and the winding switching device 100 according to the control program 510.

The processor 501 is, for example, a central processing unit (CPU). However, the processor 501 is not limited to a CPU. The processor 501 may be a graphics processing unit (GPU). The processor 501 is, for example, a multi-core processor. The processor 501 may be a single core processor. The processor 501 may be, for example, an application specific integrated circuit (ASIC), or a programmable logic device such as a gate array or a field programmable gate array (FPGA). In this case, the ASIC or programmable logic device is configured to be able to execute the same processing as the control program 510.

The I/F 504 is connected to the rotation sensor 201, the torque sensor 202, the sensor 71, the sensor 81 and the gear shift instruction device 90. The I/F 504 is, for example, an input/output interface or a communication interface. The I/F 504 receives a detection signal of the rotation speed of the motor 20 output from the rotation sensor 201. The I/F 504 receives a detection signal of the output torque of the motor 20 output from the torque sensor 202. The I/F 504 receives a detection signal of the depression amount of the brake pedal output from the sensor 71. The I/F 504 receives a detection signal of the depression amount of the accelerator pedal output from the sensor 81. The I/F 504 receives a gear shift instruction signal output from the gear shift instruction device 90.

### Configuration of Winding Switching Device

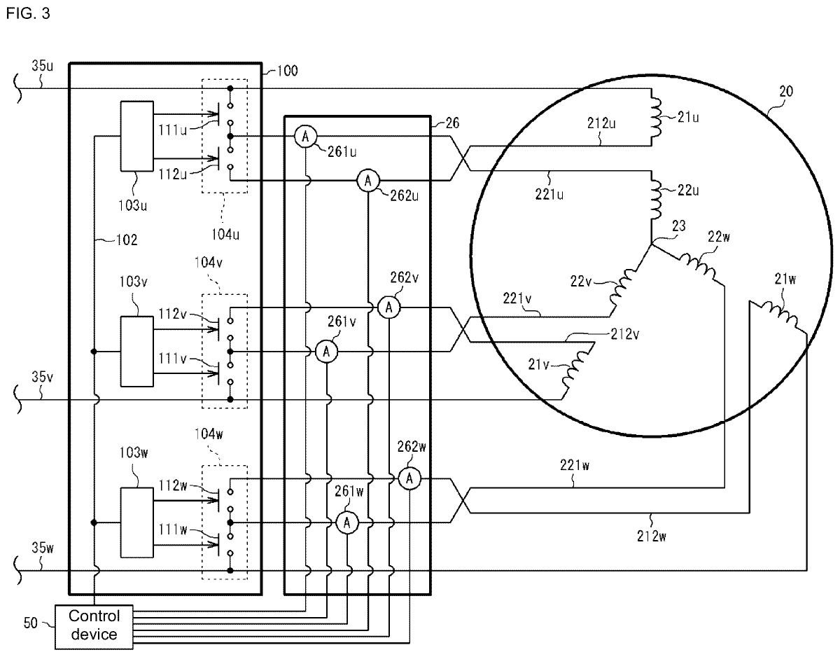

FIG. 3 is a circuit diagram showing an example of a configuration of the winding switching device according to the first embodiment. The motor 20 includes a plurality of windings 21u, 22u, 21v, 22v, 21w, and 22w. The windings 21u and 22u correspond to the U-phase, the windings 21v and 22v correspond to the V-phase, and the windings 21w and 22w correspond to the W-phase. However, the number of windings for each phase is not limited to two, and may be three or more. The windings 22u, 22v, and 22w are connected at a neutral point 23.

The winding switching device 100 switches the connection states of the windings 21u, 22u, 21v, 22v, 21w, and 22w for each phase between a first connection state and a second connection state. The winding switching device 100 includes control circuits 103u, 103v, and 103w, and switching circuits 104u, 104v, and 104w.

Under the control of the control device 50, the switching circuits 104u, 104v, and 104w switch the connection state of the windings 21u, 22u, 21v, 22v, 21w, and 22w between a state in which two windings are connected in series and a state in which one winding is connected. For example, in the U-phase, the state in which two windings are connected in series is a state in which a first terminal of the winding 21u is connected to the power line 35u, a second terminal is connected to a first terminal of the winding 22u via a relay 112u, and a second terminal of the winding 22u is connected to the neutral point 23. On the other hand, the state in which one winding is connected, is a state in which the first terminal of the winding 22u is connected to the power line 35u via a relay 111u, and the second terminal of the winding 22u is connected to the neutral point 23. The same applies to the V-phase and the W-phase as well. The state in which two windings are connected in series is an example of the first connection state. The state in which one winding is connected is an example of the second connection state. Here, the winding 21u is a first winding, and the winding 22u is a second winding.

The connection relationship between the winding switching device 100, the power line 35u, and the motor 20 will be described below as a representative for the U-phase. The V-phase and W-phase are similar, and therefore the description will be omitted.

The power line 35u is connected to a first terminal of the winding 21u. A power line 212u extends from the second terminal of the winding 21u. A power line 221u extends from the first terminal of the winding 22u.

The switching circuit 104u includes the relays 111u and 112u. The relays 111u and 112u are, for example, mechanical (electromagnetic) relays. However, there is no limitation to this, and the relays 111u and 112u may be semiconductor relays. The relays are divided into an input side and an output side. In the case of a mechanical relay, for example, the input side is constituted by an electromagnetic coil, and the output side is constituted by a contact. In the case of a semiconductor relay, for example, the input side is constituted by a light-emitting diode, and the output side is constituted by a light-receiving element, a MOSFET, and an IGBT. When a control signal is input to the input side of a relay, the switch on the output side is set to ON or OFF.

The power line 35u is led into the winding switching device 100. In the winding switching device 100, the power line 35u branches off at an intermediate point and is connected to the first terminal of the relay 111u. The second terminal of the relay 111u is connected to the first terminal of the relay 112u. The power lines 212u and 221u extend from the motor 20 and are led into the winding switching device 100. The power line 221u extending from the winding 22u is connected to a connection point between the second terminal of the relay 111u and the first terminal of the relay 112u. The second terminal of the relay 112u is connected to the power line 212u extending from the winding 21u.

When the relay 111u is in an OFF state and the relay 112u is in an ON state, the windings 21u and 22u are in the first connection state. When the relay 111u is in the ON state and the relay 112u is in the OFF state, the winding 21u is in the second connection state.

A communication line extending from the control circuit 103u is connected to each of the input sides (electromagnetic coil sides) of the relays 112u and 111u. A communication line 102 extending from the control device 50 is connected to the control circuit 103u. The control device 50 transmits, via the communication line 102, a switching signal SS that indicates which connection state of the windings is to be set. For example, the switching signal SS indicates the first connection state when it is at a LOW level, and indicates the second connection state when it is at a HIGH level. Alternatively, the switching signal SS may be data including information indicating which relays to set to ON or OFF. Here, the LOW level is, for example, the potential of the body of the vehicle, and the HIGH level is, for example, the potential of the power source supplied to the control device 50.

The control circuit 103u sets the relays 112u and 111u to ON or OFF by applying control signals to the input sides of the relays 112u and 111u, respectively. Specifically, when the control circuit 103u receives a switching signal SS for switching the connection state of the windings 21u and 22u from the first connection state to the second connection state from the control device 50, the control circuit 103u sets the relay 111u to the ON state and the relay 112u to the OFF state. When the control circuit 103u receives a switching signal SS switching the connection state of the windings 21u and 22u from the first connection state to the second connection state from the control device 50, the control circuit 103u sets the relay 111u to the OFF state and the relay 112u to the ON state.

The control circuit 103u is constituted by, for example, a plurality of logic circuits (AND circuits, NOT circuits, latch circuits, etc.). In another example, the control circuit 103u is constituted by a processor. For example, the control circuit 103u is constituted by a one-chip microcomputer. The control circuit 103u may be constituted by a programmable logic device such as an ASIC or an FPGA.

The measurement unit 26 is provided on the power lines connecting the winding switching device 100 and the motor 20. The measurement unit 26 includes phase current sensors and relay current sensors. A phase current sensor 261u is provided on the power line 221u, and a relay current sensor 262u is provided on the power line 212u. The phase current sensor 261u measures the current flowing through the U-phase when the windings 21u and 22u are in the first connection state and the second connection state. Hereinafter, the current measured by the phase current sensor is referred to as a phase current in some cases. A signal or information indicating the value of the current measured by the phase current sensor 261u is sent to the control device 50.

The relay current sensor 262u measures the current flowing through the power line 212u connected to the second terminal of the relay 112u. When the connection state of the windings 21u and 22u is switched from the first connection state to the second connection state, the relay current sensor 262u measures the current of the power line 212u that is to be cut off by the relay 112u that is set to OFF. Hereinafter, the current measured by the relay current sensor is referred to as a relay current in some cases. A signal or information indicating the value of the current measured by the relay current sensor 262u is sent to the control device 50.

Similarly, for the V-phase, a phase current sensor 261v is provided on the power line 221v, and a relay current sensor 262v is provided on the power line 212v. Similarly, for the W-phase, a phase current sensor 261w is provided on the power line 221w, and a relay current sensor 262w is provided on the power line 212w. Note that when the winding switching system 10 is formed without the relay current being measured, it is not necessary to provide a relay current sensor.

Note that it is sufficient that the measurement unit 26 is provided on the power lines connecting the winding switching device 100 and the motor 20, and the measurement unit 26 may be provided inside the winding switching device 100 or inside the motor 20.

### Functions of Control Device

Returning to FIG. 1, functions of the control device 50 will be described. The control device 50 has the functions of a first opening unit 511, a first determination unit 512, a first connection unit 513, a second opening unit 514, a second determination unit 515, and a second connection unit 516. When the processor 501 executes the control program 510, the functions of the first opening unit 511, the first determination unit 512, the first connection unit 513, the second opening unit 514, the second determination unit 515, and the second connection unit 516 are realized. Only the U-phase will be described, but the same applies to the V-phase and W-phase as well. An example in which the connection state is switched from a first connection state to a second connection state, and then switched from the second connection state to the first connection state will be described below.

### First Opening Unit

The first opening unit sets the first relay to OFF when switching the connection state from the first connection state to the second connection state. The first relay is a relay that is set to ON in the first connection state. Here, the first relay is the relay 112u and the second relay is the relay 111u.

Since the initial state is the first connection state, the relay 111u is set to OFF and the relay 112u is set to ON. Specifically, the control device 50 transmits a switching signal SS indicating that the relay 111u is to be set to OFF and the relay 112u is to be set to ON, to the control circuit 103u. Upon receiving the switching signal SS, the control circuit 103u sets the relay 111u of the switching circuit 104u to OFF and sets the relay 112u to ON.

When the connection state of the winding is switched from the first connection state to the second connection state, the first opening unit 511 sets the first relay, which is the relay 112u, to OFF. Specifically, the control device 50 transmits, for example, a switching signal SS indicating that the relay 112u is to be set to OFF to the control circuit 108u. Upon receiving the switching signal SS, the control circuit 103u sets the relay 112u of the switching circuit 104u to OFF.

### First Determination Unit

The first determination unit determines whether or not the contact of the first relay set to OFF by the first opening unit is in an open state.

### Interruption of Current by Relay

The mechanical relay is constituted by an electromagnet and a switch. If the relay is an A-contact relay, when the current flowing through the electromagnet of the relay is stopped, the relay is set to OFF. An A-contact relay is also called a normally off relay. When the current is stopped, the electromagnet that was acting as a magnet loses its magnetic effect, and the movable segment of the switch of the relay that was attracted by the electromagnet is pulled away by the force of an elastic body such as a spring. Due to the movable segment being pulled away, a first contact provided on the movable segment of the switch and a second contact provided on the fixed segment are pulled away from each other. Due to the first contact and the second contact being pulled away from each other, the first contact and the second contact enter an open state, and the current flowing through the switch is interrupted. For this reason, after the current in the electromagnet of the relay is stopped, a period of time until when the current flowing through the switch is interrupted involves a mechanical operation, and it takes, for example, about 10 ms. Note that the time from when the current in the electromagnet of the relay is stopped until when the current flowing through the switch is interrupted is sometimes called the reset time of the relay.

In addition, relays having a mechanical structure have a different relay reset time for each individual relay due to manufacturing variations and the like. Furthermore, in order to protect a driving element, such as a MOSFET, that drives the electromagnet of the relay, a diode is connected in parallel to the electromagnet of the relay in some cases. This is because the magnetic energy stored in the coil of the electromagnet is circulated by the diode and absorbed as a current that circulates through the coil of the electromagnet and the diode. The current circulating through the coil of the electromagnet and diode gradually decays, but if such current is sufficient to attract the movable segment of the switch, the switch allows electricity to flow therethrough. For this reason, the relay reset time becomes longer than expected in some cases.

In view of this, the first determination unit 512 of the present disclosure determines whether or not the contact of the first relay set to OFF by the first opening unit is in an open state. Specifically, for example, the first determination unit 512 determines that the contact of the first relay is in an open state when a current measured by a current sensor that measures a current flowing through a switch including the contact of the first relay is less than or equal to a threshold value.

### Case Where Current Sensors Are Provided on Power Lines Connecting Relays and Motor Windings

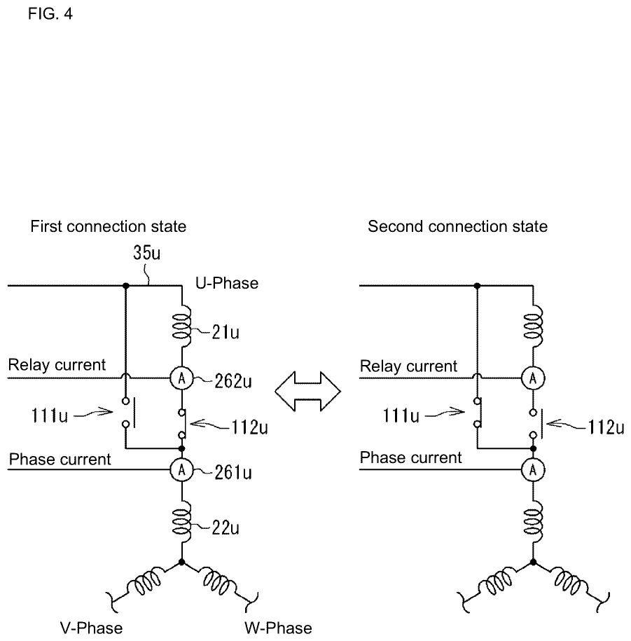

FIG. 4 is a circuit diagram showing an example of a configuration of the current sensors and the windings according to the first embodiment. In FIG. 4, the current sensor that measures the current flowing through the switch including the contact of the first relay is the phase current sensor 261u. FIG. 4 shows only the U-phase, but the same applies to the V-phase and W-phase as well. The phase current sensor 261u is inserted in the power line 221u connecting a connection point at which the second terminal of the relay 111u and the first terminal of the relay 112u are connected and the first terminal of the winding 22u. The phase current sensor 261u measures the current flowing through the power line 221u.

First, the current flowing through the switch including the contact of the first relay, which has been set to OFF, is measured. The relay that is set to ON in the first connection state is the relay 112u. Accordingly, the relay 112u corresponds to the first relay. On the other hand, the relay that is set to OFF in the first connection state is the relay 111u. Accordingly, the relay 111u is the second relay. When switching from the first connection state to the second connection state, the first opening unit 511 sets the relay 112u, which is the first relay, from ON to OFF. On the other hand, during the period in which the relay 112u is set from ON to OFF, the relay 111u is not set to ON. As a result, the phase current sensor 261u measures only the current flowing through the path of the winding 21u, the relay 112u, and the winding 22u. Accordingly, the phase current sensor 261u can measure the current flowing through the switch including the contact of the relay 112u.

### Case Where Current Sensors Are Provided on Power Lines Connecting Power Supply Circuit and Motor

Although the phase current sensor 261u has been described above as an example of a current sensor that measures the current flowing through a switch including the contact of the first relay, the present disclosure is not limited to a phase current sensor. The current sensor may be provided on a power line connecting the power supply circuit and the motor. In FIG. 1, the power converter 30 corresponds to a power supply circuit. The current sensor 38u corresponds to a current sensor that measures the current flowing through the first relay. The current sensor 33u is provided on the power line 35u that connects the power converter 30 and the motor 20. Note that the current sensor may be provided in the power converter 30 or in the winding switching device 100.

In this case as well, the relay 112u corresponds to the first relay, and the relay 111u corresponds to the second relay. When switching from the first connection state to the second connection state, the first opening unit 511 sets the relay 112u, which is the first relay, from ON to OFF. On the other hand, during the period in which the relay 112u is set from ON to OFF, the relay 111u is not set to ON. As a result, the current sensor 33u measures the current flowing through the power line 35u, and thus measures only the current flowing through the path of the winding 22u, the relay 112u, and the winding 21u. Accordingly, the current sensor 33u can measure the current flowing through the switch of the relay 112u.

### Determination Method

The first determination unit 512 determines that the contact of the first relay is in an open state when the current measured by the current sensor is less than or equal to a threshold value.

Specifically, when the current measured by the phase current sensor 261u or the current sensor 33u is less than or equal to a threshold value, it is determined that the contact of the first relay, which is the relay 112u, is in an open state. The threshold value may be set to a value close to zero, but may also be set to a value lower than the current that normally flows, with consideration given to noise and the like.

### First Connection Unit

The first connection unit sets the second relay to ON when the first determination unit determines that the contact of the first relay is in an open state.

In this example, the first relay is the relay 112u and the second relay is the relay 111u. Accordingly, when the first determination unit 512 determines that the contact of the relay 112u is in an open state, the first connection unit 513 sets the relay 111u to ON. Specifically, for example, the first connection unit 513 transmits a switching signal SS indicating that the relay 111u is to be set to ON, to the control circuit 103u. Upon receiving the switching signal SS, the control circuit 103u sets the relay 111u to ON. As a result, the connection state of the windings 21u and 22u is set to the second connection state.

Note that in the above-described example, the first opening unit 511, the first determination unit 512, and the first connection unit 513 were described as being provided in the control device 50, but the first opening unit 511, the first determination unit 512, and the first connection unit 513 may also be provided in the control circuit 103u. In this case, the control circuit 103u is constituted by, for example, a one-chip microcomputer. Such a one-chip microcomputer includes, for example, a processor, a non volatile memory, a volatile memory, and the like. The control program is stored in a non-volatile memory. The processor of the one-chip microcomputer executes a control program, whereby the functions of the first opening unit 511, the first determination unit 512, and the first connection unit 513 are realized. The phase current sensor 261u may send a signal indicating the value of the measured current or data including information to the control circuit 103u.

In addition, the first opening unit 511 may perform notification of an instruction to suppress power to the power supply circuit that supplies power for driving the motor, and set the first relay to OFF. For example, when the first opening unit 511 performs notification of the instruction to suppress power, the control device 50 that receives the instruction to suppress power controls the power converter 30 to turn off or suppress the power for driving the motor 20. By setting the relay to OFF when the current flowing through the winding is low, the risk of fusion of the contacts of the relays can be reduced and the life of the relays can be extended.

The first connection unit may also set the second relay to ON, and perform notification of an instruction to restore the suppressed power to the state before suppression to the power supply circuit that supplies power for driving the motor. For example, upon receiving the instruction to restore the suppressed power to the state before suppression, the control device 50 controls the power converter 30 to return the current for driving the motor 20 to the state before suppression. After the winding switching system switches the connection state of the windings, the motor 20 can quickly return to the original state.

In addition, when switching the connection state from the first connection state to the second connection state, the first opening unit may set the first relay to OFF upon receiving a notification indicating that the power for driving the motor has been suppressed. For example, the control device 50 first controls the power converter 30 to turn off or suppress the power for driving the motor 20. The control device 50 then sends a notification indicating that the power for driving the motor has been suppressed, to the first opening unit 511. Upon receiving the notification indicating that the power has been suppressed, the first opening unit 511 sets the first relay to OFF. This allows the relay to be set to OFF when the current flowing through the winding is low, which can reduce the risk of fusion of the contact of the relay and extend the life of the relay.

### Second Opening Unit

The second opening unit sets the second relay to OFF when switching the connection state from the second connection state to the first connection state.

In this example, the first relay is the relay 112u and the second relay is the relay 111u. Accordingly, the second opening unit 514 sets the relay 111u, which is the second relay, to OFF when switching the connection state from the second connection state to the first connection state. Specifically, the control device 50 transmits, for example, a switching signal SS indicating that the relay 111u is to be set to OFF, to the control circuit 103u. Upon receiving the switching signal SS, the control circuit 103u sets the relay 111u of the switching circuit 104u to OFF.

### Second Determination Unit

The second determination unit determines whether or not the contact of the second relay set to OFF by the second opening unit is in an open state. Specifically, for example, the second determination unit 515 determines that the contact of the second relay is in an open state when the current measured by the current sensor that measures the current flowing through the switch including the contact of the second relay is less than or equal to a threshold value.

First, the current flowing through the switch including the contact of the second relay, which has been set to OFF, is measured. Since the second relay is the relay 111u, the second determination unit 515 determines that the contact of the relay 111u, which is the second relay, is in an open state when the current measured by the current sensor that measures the current flowing through the switch of the relay 111u is less than or equal to a threshold value.

When switching from the second connection state to the first connection state, the second opening unit 514 sets the second relay, which is the relay 111u, from ON to OFF. On the other hand, during the period in which the relay 111u is set from ON to OFF, the first relay, which is the relay 112u, has not yet been set to ON. As a result, the phase current sensor 261u measures only the current flowing through the path of the relay 111u and the winding 22u. Thus, the phase current sensor 261u can measure the current flowing through the switch of the relay 112u. Note that the same applies to the case where the current sensor is provided on the power line connecting the power supply circuit and the motor. However, the second determination unit 515 determines whether or not the contact of the second relay is in an open state based on the current measured by the current sensor 33u.

Accordingly, whether the connection state of the windings is switched from the first connection state to the second connection state or from the second connection state to the first connection state, the phase current sensor 261u can measure the current flowing through the switches of the relay 111u and the relay 112u. For this reason, the current sensor can be shared by the first determination unit and the second determination unit. However, there is no limitation to this, and a current sensor may be provided in each of the first relay and the second relay.

### Second Connection Unit

The second connection unit sets the first relay to ON when the second determination unit determines that the contact of the second relay is in an open state. In this example, since the first relay is the relay 112u, when the second determination unit 515 determines that the contact of the relay 111u is in an open state, the second connection unit 516 sets the relay 112u to ON. More specifically, the second connection unit 516 transmits a switching signal SS indicating that the relay 112u is to be set to ON, to the control circuit 103u. Upon receiving the switching signal SS, the control circuit 103u sets the relay 112u to ON. This causes the connection state of the windings 21u and 22u to be set to the first connection state.

### Operation of Winding Switching System

Next, the operation of the winding switching system 10 will be described. The control device 50 executes winding switching processing due to the processor 501 executing the control program 510.

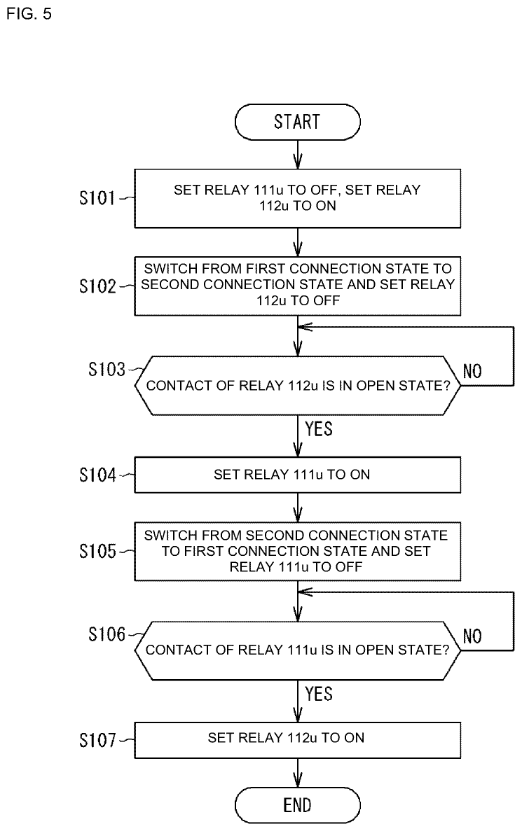

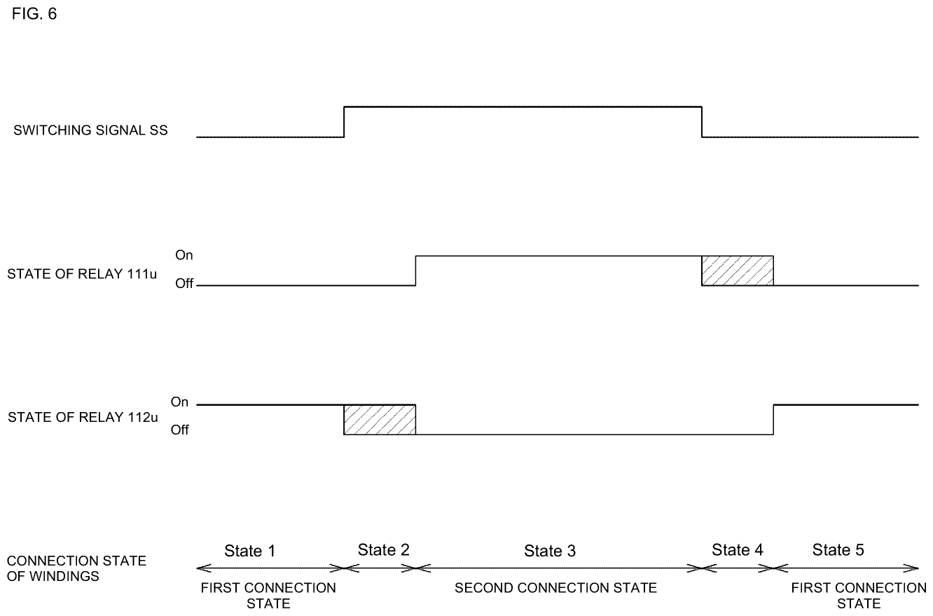

FIG. 5 is a flowchart showing an example of winding switching processing performed by the control device according to the first embodiment. FIG. 6 is a timing chart showing an example of the winding switching processing performed by the control device according to the first embodiment. An example in which the control device 50 switches the connection state of the windings from the first connection state to the second connection state, and then from the second connection state to the first connection state will be described below.

### Step S101

In this example, since the initial state is the first connection state, the control device 50 transmits a switching signal SS indicating that the relay 111u is to be set to OFF and the relay 112u is to be set to ON, to the control circuit 103u (step S101), and proceeds to step S102. Upon receiving the switching signal SS, the control circuit 103u sets the relay 111u to OFF and sets the relay 112u to ON. The position of state 1 in the timing chart shown in FIG. 6 indicates this state.

### Step S102

When switching the connection state from the first connection state to the second connection state, the first opening unit 511 sets the first relay to OFF (step S102). In this example, the first relay is the relay 112u. The first opening unit 511 sets the relay 112u, which is the first relay that has been set to ON, to OFF. After setting the relay 112u to OFF, the control device 50 proceeds to step S102. The position at which a transition occurs from state 1 to state 2 in the timing chart shown in FIG. 6 indicates this state.

### Step S103

The first determination unit determines whether or not the contact of the first relay that has been set to OFF by the first opening unit is in an open state (step S103).

First, the current flowing through the contact of the first relay, which has been set to OFF, is measured. The first relay is the relay 112u. The phase current sensor 261u or the current sensor 33u measures the current flowing through the relay 112u.

If the current measured by the phase current sensor 261u or the current sensor 33u is less than or equal to a threshold value, the first determination unit 512 determines that the contact of the relay 112u is in an open state (YES in step S103), and proceeds to step S104. On the other hand, if the current measured by the phase current sensor 261u or the current sensor 33u is greater than the threshold value, it is determined that the contact of the relay 112u is not in an open state (NO in step S103), the processing returns to step S103, the current is measured again by the phase current sensor 261u or the current sensor 33u, and the first determination unit 512 determines whether or not the measured current is less than or equal to the threshold value. The position of state 2 in the timing chart shown in FIG. 6 indicates this state.

### Step S104

The first connection unit sets the second relay to ON when the first determination unit determines that the contact of the first relay is in an open state (step S104).

When the first determination unit 512 determines that the contact of the relay 112u is in an open state (YES in step S103), the first connection unit 513 transmits a switching signal SS indicating that the second relay, which is the relay 111u, is to be set to ON, to the control circuit 103u. Upon receiving the switching signal SS, the control circuit 103u sets the relay 111u to ON. As a result, the connection state of the windings 21u and 22u is set to the second connection state. The position at which a transition occurs from state 2 to state 3 in the timing chart shown in FIG. 6 indicates this state. Subsequently, when the connection state is switched from the second connection state to the first connection state, the processing proceeds to step S105.

### Step S105

When switching the connection state from the second connection state to the first connection state, the second opening unit 514 sets the second relay to OFF (step S105). In this example, the second relay is the relay 111u. The second opening unit 514 sets the relay 111u, which has been set to ON, to OFF. After setting the relay 111u to OFF, the control device 50 proceeds to step S106. The position at which a transition occurs from state 3 to state 4 in the timing chart shown in FIG. 6 indicates this state.

### Step S106

The second determination unit determines whether or not the contact of the second relay that has been set to OFF by the second opening unit is in an open state (step S106).

First, the second determination unit 515 measures the current flowing through the contact of the second relay that has been set to OFF. The second relay is the relay 111u. The current flowing through the relay 111u is measured by the phase current sensor 261u or the current sensor 33u.

If the current measured by the phase current sensor 261u or the current sensor 33u is less than or equal to the threshold value, the second determination unit 515 determines that the contact of the relay 111u is in an open state (YES in step S106), and proceeds to step S107. On the other hand, if the current measured by the phase current sensor 261u or the current sensor 33u is greater than the threshold value, it is determined that the contact of the relay 111u is not in an open state (NO in step S106), the processing returns to step S106, the current is measured again by the phase current sensor 261u or the current sensor 33u, and the second determination unit 515 determines whether or not the measured current is less than or equal to the threshold value. The position of state 4 in the timing chart shown in FIG. 6 indicates this state.

### Step S107

The second connection unit sets the first relay to ON when the second determination unit determines that the contact of the second relay is in an open

State (step S107).

When the second determination unit 515 determines that the contact of the relay 111u is in an open state (YES in step S106), the second connection unit 516 transmits a switching signal SS indicating that the relay 112u is to be set to ON, to the control circuit 103u. Upon receiving the switching signal SS, the control circuit 103u sets the relay 112u to ON. This causes the connection state of the windings 21u and 22u to be set to the first connection state. The position at which a transition occurs from state 4 to state 5 in the timing chart shown in FIG. 6 indicates this state. Then, after the relay 112u is set to ON, the winding switching processing ends.

As described above, when the connection state of the windings is switched from the first connection state to the second connection state, or when the connection state of the windings is switched from the second connection state to the first connection state, the contacts of the relays 111u and 112u are first in an open state, and then the connection state of the windings is switched. This prevents the windings from short circuiting even when a plurality of relays are used, and suppresses the risk of a large induced current, a torque fluctuation, and contact sticking due to a large current. In view of these points, the present disclosure is preferably applied to a mechanical relay.

Also, for convenience of description, the U-phase, V-phase, and W-phase have been described as being treated as being independent of each other, but the connection state of the windings may be changed simultaneously for all phases. In this case, if the relay contacts are determined as being open when the values of the current sensors for the U-phase, V-phase, and W-phase are all zero, and the connection state is switched, it is possible to avoid inconsistency among the phases. In addition, by using a relay that opens and closes a plurality of circuits at the same time with one coil, it is possible to open and close the circuits of all phases at the same time. This allows all phases to be operated in a unified manner by controlling a single relay, thereby simplifying the circuit and facilitating control.

### Second Embodiment

A winding switching device of a second embodiment includes a voltage sensor that measures a voltage across a switch including the contact of a first relay, and a determination unit determines whether or not an output switch is in an electrically open state based on the measured voltage.

### Configuration of Winding Switching Device

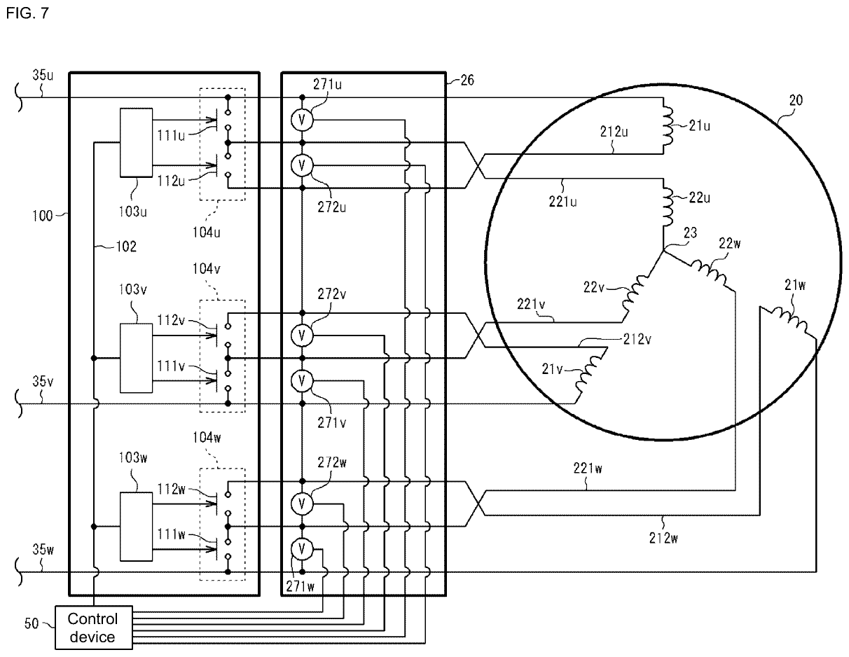

FIG. 7 is a circuit diagram showing an example of a configuration of a winding switching device and a measurement unit according to the second embodiment. The second embodiment differs from the first embodiment in the configuration of the measurement unit 26, but the other configurations are the same. Description of configurations similar to those in the first embodiment will be omitted, and only the different portions will be described, with identical reference numerals being used for identical configurations.

### Measurement Unit

The measurement unit 26 includes the voltage sensors 271u, 272u, 271v, 272v, 271w, and 272w. The voltage sensor 271u is connected between the U-phase power line 35u and the power line 221u, and measures the voltage across the switch of the relay 111u. The voltage sensor 272u is connected between the U-phase power line 221u and the power line 212u, and measures the voltage across the switch of the relay 112u. The voltage sensor sends information or a signal indicating the measured voltage to the control device 50. The same applies to the V-phase and the W-phase as well.

### Functions of Control Device

The second embodiment differs from the first embodiment in the functions of the first determination unit 512 and the second determination unit 515, but the other functions are the same. Also, the first determination unit 512 and the second determination unit 515 measure different relays but have the same functions.

### First Determination Unit, Second Determination Unit

The first determination unit determines whether or not the contact of the first relay is in an open state based on a voltage measured by a voltage sensor that measures a voltage of the first relay.

First, the first determination unit 512 measures the voltage across the output switch of the first relay that has been set to OFF. When the connection state of the windings is switched from the first connection state to the second connection state, the relay that is set to ON in the first connection state, which is the first connection state, is the relay 112u, and the relay 112u corresponds to the first relay. Thus, the voltage sensor 272u measures the voltage across the switch of the relay 112u.

On the other hand, when the connection state of the windings is switched from the second connection state to the first connection state, the second determination unit 515 determines whether or not the contact of the relay 111u is in an open state based on the voltage across the switch of the relay 111u, which is the second relay, measured by the voltage sensor 271u.

Then, the first determination unit 512 and the second determination unit 515 determine that the contact of the relay is in an open state, for example, when the voltage measured by the voltage sensor is greater than or equal to a threshold value. When the contact of the relay is in a connected state, the voltage across the switch that includes the contact is zero. On the other hand, when the contact of the switch of the relay is separated and in an open state, the voltage across the switch is a value completely different from zero.

That is, when the contact of the switch of the relay is in an open state, the ends on one side of the windings 21u and 22u, which are the stator, are in an open state. At this time, the rotor of the motor 20 is rotating, some voltage is generated in the windings 21u and 22u that are the stator, and this voltage has a value completely different from zero. The voltage sensors 271u and 272u measure this voltage, and if the voltage is greater than or equal to a threshold value, it is determined that the output switch of the relay is in an electrically open state.

### Operation of Winding Switching System

The second embodiment differs from the first embodiment in the operations of steps S103 and S106, but the other operations are the same. In step S103 and step S106, different relays are measured, but the operations are the same.

### Step S103

The first determination unit determines whether or not the contact of the first relay that has been set to OFF by the first opening unit is in an open state (step S103).

The first determination unit 512 measures the voltage across the switch of the first relay that has been set to OFF. The first relay is the relay 112u. The voltage sensor 272u measures the voltage across the switch of the relay 112u.

If the voltage measured by the voltage sensor 272u is greater than or equal to the threshold value, it is determined that the contact of the switch is in an open state (YES in step S103), and the processing proceeds to step S103. On the other hand, if the voltage measured by the voltage sensor 272u is less than the threshold value, it is determined that the contact of the switch is not in an open state (NO in step S103), the processing returns to step S103, and the first determination unit 512 again determines whether or not the voltage measured by the voltage sensor 272u is greater than or equal to the predetermined threshold value.

As described above, the voltage sensor can also be used to determine whether or not the contact of the relay is in an open state. Accordingly, in the second embodiment as well, the connection state of the windings is switched after passing through a state in which both of the contacts of the switches of the relays 111u and 112u are in an open state. This prevents the windings from short-circuiting even when a plurality of relays are used, and can suppress the risk of a large induced current, a torque fluctuation, and contact sticking due to a large current.

### Third Embodiment

A vehicle motor driving system of a third embodiment includes an AC motor in which stators for respective phases include a plurality of windings, the AC motor driving wheels of a vehicle, a power converter that converts DC power into three-phase AC power that drives the AC motor, and a winding switching system that switches the connection state of the plurality of windings.

The AC motor that drives the wheels of the vehicle is a traveling motor 20 that generates propulsive force for the electric vehicle. That is, the motor 20 is a drive motor that is connected to wheels 60 and drives the wheels 60. The motor 20 is driven by three phase AC power. The motor 20 includes stators for the respective phases that include a plurality of windings. The characteristics of the motor 20 can be changed by switching between the plurality of windings.

The power converter 30 is an inverter that converts DC power supplied from the battery 40 into three phase AC power. The power converter 30 includes a leg for each phase. The leg for each phase includes a switch. The switches perform switching to convert DC power into three phase AC power.

The winding switching system 10 is a winding switching system that switches the connection state of a plurality of windings of a motor in which the stator of each phase includes the plurality of windings. The winding switching system 10 includes a first relay, a second relay, a first opening unit, a first determination unit, and a first connection unit. The first relay is set to ON when the connection state of the plurality of windings is a first connection state. The second relay is set to OFF when the connection state of the plurality of windings is the first connection state. The first opening unit sets the first relay to OFF when switching the connection state from the first connection state to the second connection state. The first determination unit determines whether or not the contact of the first relay set to OFF by the first opening unit is in an open state. The first connection unit sets the second relay to ON when the first determination unit determines that the contact of the first relay is in an open state.

As described in the first embodiment as well, due to the winding switching system 10 having such a configuration, when the connection state of the windings is switched, all relays that switch the connection state of the windings are first set to OFF, and then the connection state is switched. This prevents the windings from short-circuiting even when a plurality of relays are used, and can suppress the risk of a large induced current, a torque fluctuation, and contact sticking due to a large current. Even in a vehicle equipped with such a winding switching system 10, it is possible to prevent a plurality of relays from entering the ON state at the same time.

### Modified Examples

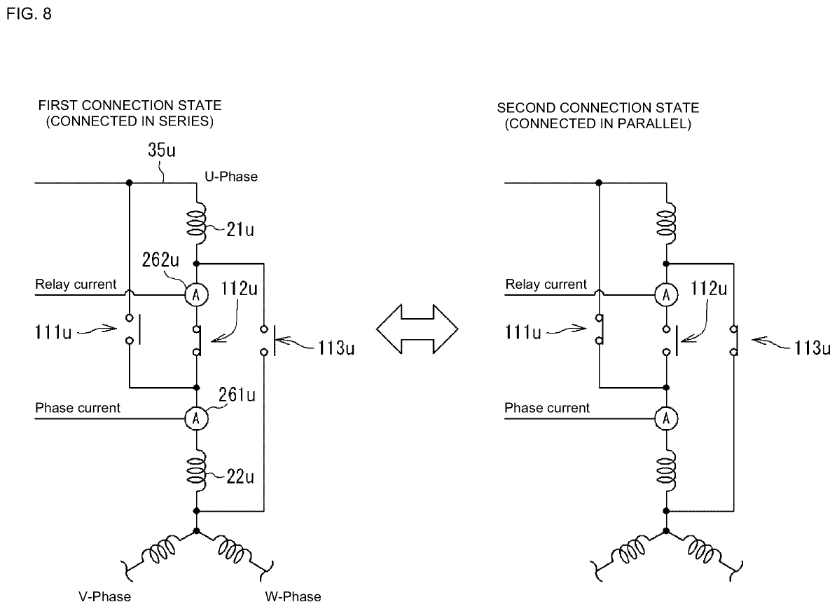

The winding switching system may further include a third relay that is set to OFF when the connection state of the plurality of windings is the first connection state. A first terminal of the third relay is connected to the second terminal of the first winding, a second terminal of the third relay is connected to the second terminal of the second winding, and the first connection unit sets the third relay to ON when switching the connection state from the first connection state to the second connection state. In FIG. 8, the third relay is the relay 118u. In addition, connection states focusing on the second winding include a first connection state in which the first winding is connected in series, and a second connection state in which the first winding is not connected in series, and in the second connection state, the first winding may be connected in parallel.

FIG. 8 is a circuit diagram showing an example of a configuration of a modified example of the winding switching device 100. FIG. 8 shows only the U-phase, but the same applies to the V-phase and the W-phase as well. Compared to the first embodiment, a relay 113u is added. The relay 113u is set to ON or OFF at the same timing as the relay 111u. The addition of relay 113u allows the winding 21u and the winding 22u to be connected in parallel. Hereinafter, the case of being connected in parallel is referred to as a second connection state in some cases. When connected in parallel, the relays 111u and 113u are set to ON, and the relay 112u is set to OFF. On the other hand, in the case of a series connection, which is the first connection state, the relays 111u and 113u are set to OFF, and the relay 112u is set to ON.

The winding switching device 100 switches the connection state of the windings of the motor 20 from a first connection state to a second connection state. Alternatively, the connection state is switched from the second connection state to the first connection state. In this case as well, when the connection state of the windings is switched between the first connection state and the second connection state, all relays that switch the connection state of the windings are set to OFF, or to ON after passing through a state in which they are set to OFF. This prevents the windings from short-circuiting even when a plurality of relays are used, and can suppress the risk of a large induced current, a torque fluctuation, and contact sticking due to a large current.

### Supplementary Note

The embodiments disclosed herein are illustrative in all respects and are not restrictive. The scope of the present disclosure is indicated not by the above-described embodiments but by the claims, and encompasses all modifications within the meaning and range equivalent to the claims. In addition, although a vehicle motor has been described as an example, there is no limitation to a vehicle motor, and the present disclosure is applicable to an AC motor in which a plurality of windings are switched by a plurality of relays to change the characteristics.

1. A winding switching system for, in a motor in which stators for respective phases each include a plurality of windings, switching a connection state of the plurality of windings, comprising:
a first relay that is set to ON when the connection state of the plurality of windings is a first connection state;
a second relay that is set to OFF when the connection state of the plurality of windings is the first connection state;
a first opening unit configured to set the first relay to OFF when the connection state is switched from the first connection state to a second connection state;
a first determination unit configured to determine whether or not a contact of the first relay that has been set to OFF by the first opening unit is in an open state; and
a first connection unit configured to set the second relay to ON when the first determination unit determines that the contact of the first relay is in an open state.

2. The winding switching system of claim 1, further including;
a second opening unit configured to set the second relay to OFF when the connection state is switched from the second connection state to the first connection state;
a second determination unit configured to determine whether or not a contact of the second relay that has been set to OFF by the second opening unit is in an open state; and
a second connection unit configured to set the first relay to ON when the second determination unit determines that the contact of the second relay is in an open state.

3. The winding switching system according to claim 1, wherein the first determination unit determines that the contact of the first relay is in an open state when a current measured by a current sensor configured to measure a current flowing through a switch including the contact of the first relay is less than or equal to a threshold value.

4. The winding switching system according to claim 3, wherein the current sensor is provided on a power line connecting the first relay and any one of the windings of the motor.

5. The winding switching system according to claim 3, wherein the current sensor is provided on a power line connecting the motor and a power supply circuit configured to supply power for driving the motor.

6. The winding switching system according to claim 1, wherein the first determination unit determines whether or not the contact of the first relay is in an open state based on a voltage measured by a voltage sensor configured to measure a voltage across a switch including the contact of the first relay.

7. The winding switching system according to claim 1,
wherein the plurality of windings include a first winding and a second winding,
a first terminal of the first relay is connected to a second terminal of the first winding,
a second terminal of the first relay is connected to a first terminal of the second winding,
a first terminal of the second relay is connected to the first terminal of the second winding, and
a second terminal of the second relay is connected to a first terminal of the first winding.

8. The winding switching system according to claim 7, further including;
a third relay that is set to OFF when the connection state of the plurality of windings is the first connection state,
wherein a first terminal of the third relay is connected to the second terminal of the first winding,
a second terminal of the third relay is connected to a second terminal of the second winding, and
the first connection unit sets the third relay to ON when switching the connection state from the first connection state to the second connection state.

9. The winding switching system according to claim 1, wherein the first opening unit performs notification of an instruction to suppress power for driving the motor to a power supply circuit configured to supply the power, and sets the first relay to OFF.

10. The winding switching system according to claim 9, wherein the first connection unit sets the second relay to ON, and performs notification of an instruction to restore the suppressed power to a state before suppression to the power supply circuit that supplies the power for driving the motor.

11. The winding switching system according to claim 1,
wherein when switching the connection state from the first connection state to the second connection state,
the first opening unit sets the first relay to OFF when a notification indicating that the power for driving the motor has been suppressed is received.

12. A vehicle motor drive system comprising:
an AC motor in which stators for respective phases each include a plurality of windings, the AC motor being configured to drive a wheel of a vehicle;
a power converter configured to convert DC power into three-phase AC power for driving the AC motor; and
the winding switching system according to claim 1, configured to switch the connection state of the plurality of windings.

13. (canceled)

14. A winding switching method for, in a motor in which stators for respective phases each include a plurality of windings, switching a connection state of the plurality of windings, the winding switching method comprising:
a step of setting a first relay that is set to ON when a connection state of the plurality of windings is a first connection state, to OFF when switching from the first connection state to a second connection state;
a step of determining whether or not a contact of the first relay that has been set to OFF by the first opening unit is in an open state; and
a step of setting a second relay that is set to OFF when the connection state of the plurality of windings is the first connection state, to ON when it is determined that the contact of the first relay is in an open state.

15. (canceled)
